(19) United States
(12) Patent Application Publication
(10) Pub. No.: US 2005/0192690 A1
(43) Pub. Date: Sep. 1, 2005

(54) Chip probing equipment and test modeling for next generation MES (300MM)

(75) Inventors: Keng-Chia Yang, Chung-Hwa City (TW); Shu-Min Chen, Chu Bei City (TW); Larry Jann, Taipei City (TW); Lieh-Jung Chen, Tainan City (TW)

Correspondence Address: THOMAS, KAYDEN, HOSTEMEYER & RISLEY LLP, 100 GALLERIA PARKWAY, SUITE 1750, ATLANTA, GA, 30339, US

(73) Assignee: Taiwan Semiconductor Manufacturing Co.

(21) Appl. No.: 10/788,173

(22) Filed: Feb. 26, 2004

(51) Int. Cl. G06F 19/00

(52) U.S. Cl. 700/96; 700/121

(57) ABSTRACT

A new solution in 300 mm Chip Probing (CP) Manufacturing Execution System (MES) design based on a SiView infrastructure. It models actual behavior making it possible to specify exact test program and equipment configuration. The test program, product file, and probe card are modeled into the MES infrastructure so that extra systems and tables requiring costly maintenance can be eliminated. With the required tester configuration built into the product class and tester capability status built into the test equipment's properties, real-time lot-equipment dispatching can occur according to the configuration. A modified version can be supported by I-EDA and PCMS.

### BACKGROUND OF THE INVENTION

1. Field of Invention

This invention relates generally to wafer testing in a semiconductor manufacturing facility and, more particularly, to integration of the Manufacturing Execution System (MES) with test equipment to improve the configuration and relationship between the wafer product and the test equipment.

2. Description of Related Art

Correct test programs are very important to maximum yield and customer satisfaction. Many methods and in-house systems are implemented to address this issue, but they do not perform well or are complicated to maintain and are manpower intensive. Current equipment and recipe modeling can not specify the exact test program and equipment configuration for all current products. Complex, high-maintenance extra systems and tables outside the MES are used to specify a test recipe, but some test recipes can not be specified exactly due to modeling limitation. Engineers now maintain the complex relationship between the product and capable testers.

The product, sort type, and probe card are all factors of test program selection but currently are not in the MES infrastructure. Current Chip Probing (CP) Manufacturing Execution System (MES) infrastructures include Poseidon (IBM's factory automation programming system) and PROMIS and their extra table or systems. PROMIS is an IBM product that provides an MES for batch, semi-batch and discrete manufacturing. PROMIS' manufacturing execution software gives visibility and control over the plant floor. Poseidon does not include the test program (test recipe) in the MES infrastructure. Only one tool group can be mapped to one product-sort, and one tool group may include many testers (test groups) that belong to different tester types (equipment). Thus, the relation between tool group and equipment is very complicated, and any change of tester configuration will impact many tool groups. There are many equipment types and tool groups currently, and one change of tester configuration can require the need to revise a large number of tool groups concurrently at considerable cost and time.

Poseidon has an extra table called a “traveler sheet” that maintains the test recipe information outside the MES, but only one product-sort can map to one test program. Since the test program is not embedded in the MES, the information cannot be applied to operation flow directly. Moreover, this model is not enough to specify the correct test program because the device under test (dut) property of a probe card will impact the test program selection.

In another infrastructure model type in PROMIS, alternative recipe and capability concepts are applied to the infrastructure to simplify the complicated relationship between the tool group and the equipment. This allows one product-sort to map several capabilities and one capability only includes the testers with same equipment type. This model reduces the quantity of capability (tool groups) resulting in easier maintenance of equipment configuration and uses product parameter to maintain the relation in test program version control.

Neither model covers the factor of the probe card's dut for test recipe control, and they cannot be applied to operation flow directly in the MES because they cannot be modeled into MES's infrastructure. Moreover, even when alternative recipe and capability concepts are applied to PROMIS' infrastructure for simplification, the tester capability model remains complex, not native, and has many extra routes created for the products with same flow due to the different capabilities. Thus a new model infrastructure system and method is needed to resolve problems of the current models. This invention provides the solution.

In U.S. Pat. No. 6,334,215 (Barker et al.) a methodology for migration of legacy application to new product architectures is discussed. In U.S. Pat. No. 6,263,255 (Tan et al.) a process control method for semiconductor manufacturing is discussed. In U.S. Pat. No. 5,867,389 (Hamada et al.) a substrate processing management system with recipe copying is discussed.

### SUMMARY OF THE INVENTION

This invention's overall objective is to provide a method for relating the test recipe, product, and test equipment. It is a more specific objective to include the test recipe and test material model within the Manufacturing Execution System (MES) infrastructure. Another objective is to be able to set the exact test recipe according to the product class, sort stage, and test data within the MES. Still other objectives are to provide the capability to set the test equipment's configuration so that the correct tester is always used and to provide the capability to request the required test equipment's configuration for each product. A final objective is to provide for the test equipment's capability status. The satisfaction of these objectives will enhance quality control and simplify system maintenance.

### BRIEF DESCRIPTION OF THE DRAWINGS

This invention will be described with reference to the accompanying drawings, wherein:

FIG. 1A, 1B, and 1C are flow diagrams showing the prior art relationship of the product to the test program, groups, and test equipment.

FIG. 2 is a flow diagram of how this new implementation is structured.

FIG. 3 is a flow diagram of a simplified model to implement an initial version of Silicon View (SiView) using support systems.

FIG. 4 is a block diagram that shows the relation of the Specification Manager (SM) classes and the relation between the SM class and actual operation flow.

### DETAILED DESCRIPTION OF THE PREFERRED EMBODIMENT

The product, sort type, and probe card are all factors of test program selection. In the prior art, the current Chip Probing (CP) software programs used in the Manufacturing Execution System (MES) infrastructure are software products Poseidon, IBM's factory automation programming system, and PROMIS, IBM's programming product that provides an MES for batch, semi-batch and discrete manufacturing, and manufacturing execution software that gives visibility and control over the plant floor.

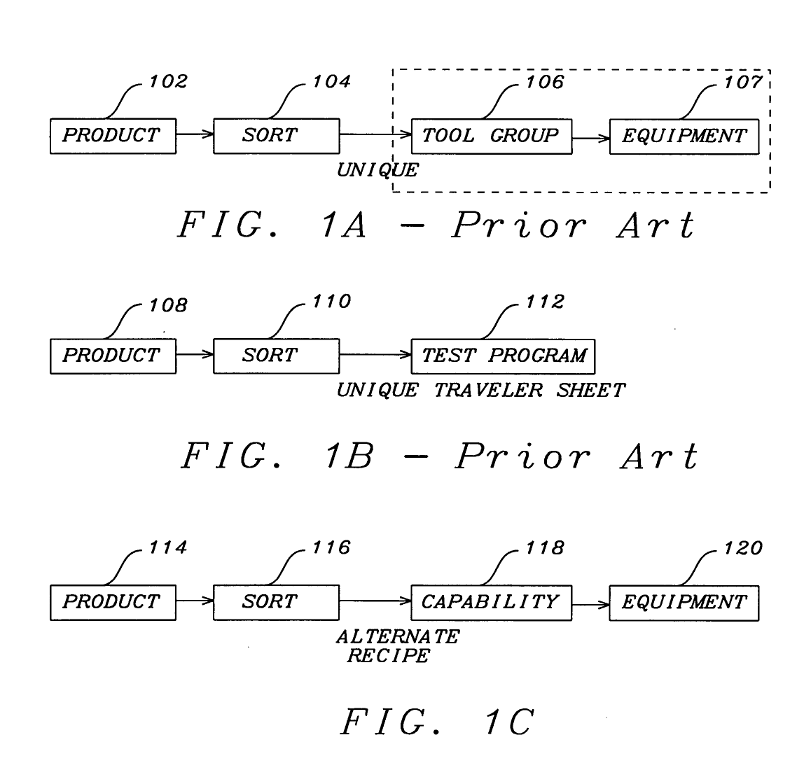

Poseidon does not include test program (test recipe) in its infrastructure. FIG. 1A shows its infrastructure model for equipment. Only one tool group can be mapped to one product-sort 102 104, and one tool group 106 may include many testers that belong to different tester types. Thus, the relation between tool group 106 and equipment 107 is very complicated, and any change of tester configuration will impact many tool groups. There are 252 equipment types and 179 tool groups currently in Poseidon's Basic Records. One change of the tester configuration may require revision of over 10 tool groups concurrently.

In the Poseidon model an extra table called “traveler sheet” is used to maintain the test recipe information outside the MES and is shown in FIG. 1B. One product-sort 108 110 can map to one test program 112 only. Since it's not embedded in MES, the information cannot be applied to the operation flow directly. Moreover, the model in itself is not enough to specify the correct test program because the device under test (dut) property of a probe card will impact the test program selection.

In the PROMIS program, the “alternative recipe” and “capability” concepts are applied to PROMIS' infrastructure to simplify the complicated relation between tool group and equipment. Seen in FIG. 1C, this allows one product-sort 114 116 to map several capabilities and one capability only 118 includes the testers with the same equipment type 120. The model reduces the quantity of capability (tool groups) thereby simplifying the maintenance of equipment configuration. Though test program version control is similar to the Poseidon model of FIG. 1B, PROMIS uses product parameter to maintain the relationship. Even with “alternative recipe” and “capability” concepts, this model is still complex and not native as many extra routes are created for the products with same flow due to the different capabilities.

Neither model covers the factor of the probe card's dut for test recipe control nor can they be applied to operation flow directly in the MES because they cannot be modeled into MES's infrastructure. A new model infrastructure system and method are needed to solve the current problems. This invention provides that new infrastructure design solution. It sets the exact test recipe according to product class, sort stage, and test data within the MES as well as provides the capability to set the test equipment's configuration.

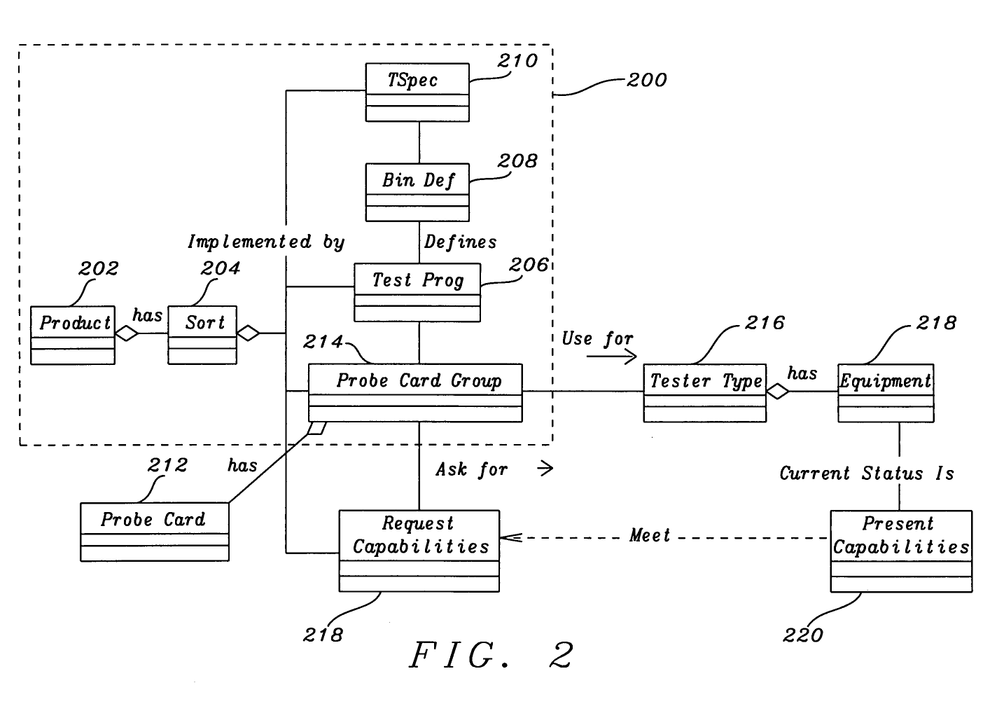

FIG. 2 shows a flow diagram of how this new equipment and test recipe model based on actual behavior is structured. The dashed-line block 201 shows how a product-sort probe card combination is mapped to a unique test program. One probe card group is only for one single type of testers. Each test program has its own bin definition and test specs (SBC/SBL criteria). This part is designed for test recipe control. The Product 202 and Sort 204 are as before. The Test Program 206, Bin Definition 208, and Test Specification (SBC/SBL) 210 are now built into MES's infrastructure. Moreover, test recipe and test material model or product file plus the Probe Card 212 associated with a Probe Card Group 214 are also included to specify the correct test program or Tester Type 216 which has specific tester Equipment 218. The “tool group” concept used in Poseidon and “alternative recipe” and “capability groups” concepts of PROMIS are no longer needed in this new equipment model. The real-time lot-to-equipment dispatch mechanism is applied according to the required configuration between the product-sort Request Capabilities 218 and the tester Present Capabilities 220. For this matching mechanism to work, the Present Capabilities 220 or capability status is built into the properties of equipment classes and the Request Capabilities 218 or the required test equipment's configuration is set in product classes. In the prior art the relationship between “tool groups” and “capability groups” and the testers is very complicated, and changes of tester configuration impacts many tools groups.

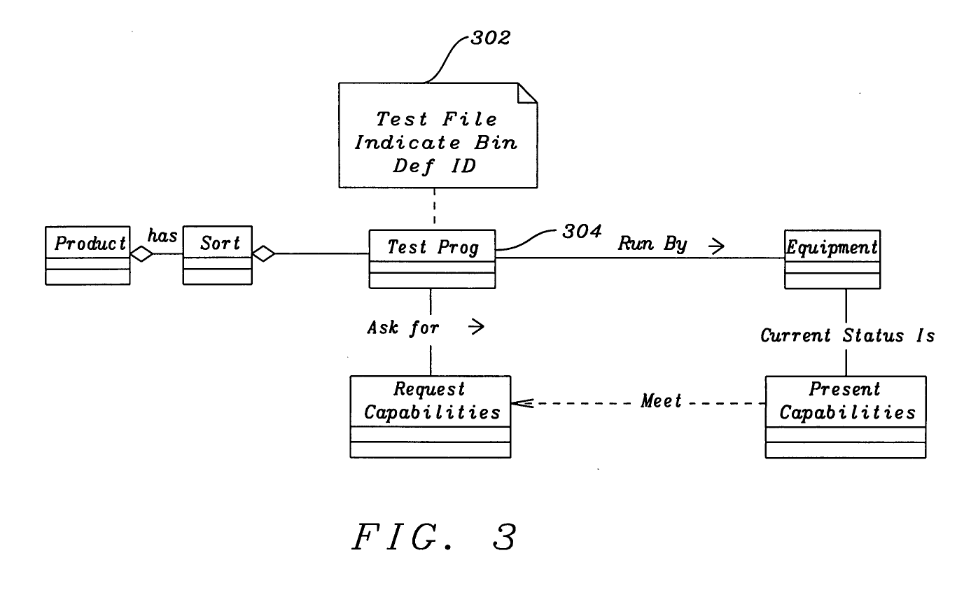

For the new implementation, the Silicon View program called SiView, an off the shelf MES program by IBM that controls the production process at the wafer level, is the 300 mm Chip Probing (CP) MES of choice. SiView is compatible with many current systems and is extendable for this implementation and other functions. It allows for using an off-the-shelf product that requires minimal coding and reduced maintenance for the MES. This reduces overall cost greatly. A simplified model to implement the initial version of SiView to make it compatible with current systems I-EDA and PCMS is shown in FIG. 3. Where I-EDA and PCMS are in use, cross-sites Tspec/Bin (technical and binary specifications) definition are implemented in I-EDA and probe card management is already implemented in PCMS language systems. These are now indicated by the Test File Indicate Bin Def ID 302. Thus, the information of PCMS is integrated into equipment setup parameter, and it will support the MES to select correct test recipe Test Program 304 and prober's product files.

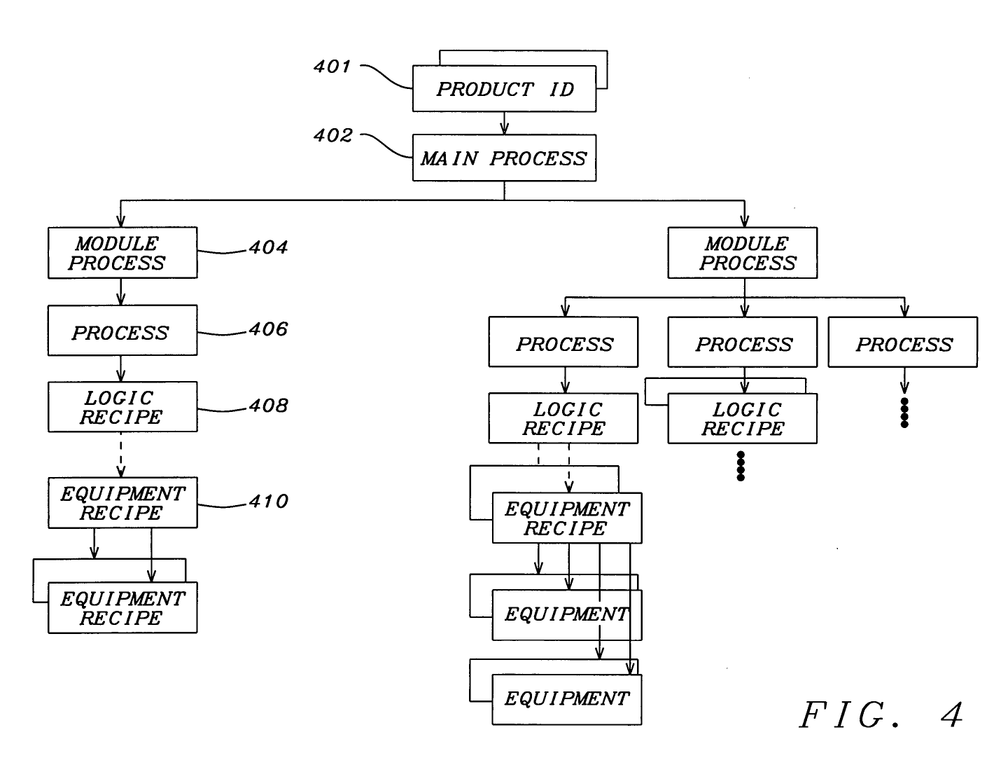

An understanding of the class architecture of SiView's infrastructure of FIG. 4 will be helpful in showing how the new method and model is implemented into SiView. The SiView infrastructure is called Specification Manager (SM) and its function is the same as the “Basic Record” in Poseidon and the “PROD” in PROMIS. FIG. 4 shows the relationship of all SM classes and the relationship between the SM class and actual operation flow. In the Si View product, Product ID 401, Main Process 402 (a main route or branch route), Module Process 404 (a stage), Process 406 (an operation in a stage), and Logic Recipe classes 408 model the user's Product and Sort entity. SiView's Equipment Recipe is then modeled as the user's Test Program. Because there is no product-dependent setting below Logic Recipe, Equipment Recipe ID 410 will be determined as follows:
Equipment Recipe name rule in SiView SM
NameSpace+Recipe ID+Version
Apply to proposed model:
TesterType+{#TPSort1->Product} {#DUT->Eqp};
{#ProductFile->Product} {#DUT->Eqp}+Version
   Where:
   #TPSort1->Product is product parameter that stored the Test Program on Sort1 by each product. #DUT->Eqp indicates what DUT dimension of the probe card this tool is set up for. It usually happens only when there are different DUT dimension probe cards of a product and designed for same tool type. The CP user will set up equipment first before the process. Whenever it is set, a target probe card is addressed for it and this change is set through an OMI interface. Using this scenario, the Test Program and Product File naming rule should be complied with.

For example:

| | |
|---|---|
| Tester Type: | HP93K |
| #TPSort1−>Product: | TM1234-Sort1-v01 |
| #ProductFile−>Product: | TM1234 |
| #DUT−>EqpTest: | 2x8 |
| Test Program: | TM1234-Sort1-v01_2x8 |
| Product File: | TM1234_2x8 |

The equipment list of this Equipment Recipe depends on the NameSpace —Tester Type (HP93K).
The Equipment Recipe ID is:
HP93K.TM1234-Sort1_v01_{—}2×8;TM1234_{—}2×8.001

Now let us look at the equipment model. The Request Capability is defined in the upper/lower limit of recipe parameter inside Logic Recipe class. Present capability status is kept in a new status table. For example:

Equipment class is:

Recipe Parameter (Need all the capability of each Eqp pre-defined).
Parameter Name=$$PIN_COUNT ($$ is special indicator for capability)
Data Type=Integer
Target Value=(Do not care)
Upper Limit=(Do not care)
Lower Limit=(Do not care)
User Current Value=No
   Logic Recipe class: Equipment Recipe+Recipe Parameter
Parameter Name=$$PIN_COUNT ($$ is special indicator for capability)
Data Type=Integer
Default Value=(Don't care)
Upper Limit=99999 (Extremely large number)
Lower Limit={#PIN->Product} (Define value by Product)
User Current Value=No

In a simplified model where other systems such as I-EDA and PCMS are supporting, the Bin definition ID/content is not defined in the SM. Instead, Bin Def ID is stated inside raw test file which is provided by the tester. The content is centrally defined in I-EDA and replicated into SiView. TSpec is also not defined in SiView and provided by central SBC/SBL languages project in I-EDA. The probe card and probe card group are not modeled in SiView but instead the present PCMS system information is used. This model can be used with the supporting systems until conversion is complete.

The method of the invention provides advantages over the prior art including eliminating significant wafer or yield loss due to an incorrect test recipe or having a wafer run on an incorrect tester, modeling actual behavior, modeling test program, product file and probe card into MES infrastructure, embedding recipe management directly into production routing including building tester configuration into product class so that real-time lot dispatching can run according to this tester configuration, providing the capability to set equipment configuration and to set the required equipment configuration for each product, modeling capability status into the properties of the equipment, and setting exact test recipe according to product, sort stage, and test material. The old equipment modeling did not specify exact test program and equipment configuration. Wrong test programs or testers might be selected due to limitation of the model or complexity of extra systems, and huge maintenance manpower spent on these extra tables beside MES. The new model will eliminate need for extra tables and systems, enhance quality control, simplify system maintenance, and improve throughput with the result of efficiency, improved yields, money saved, and enhanced customer satisfaction.

While the invention has been particularly shown and described with reference to preferred embodiments thereof, it will be understood by those skilled in the art that various changes in form and details may be made without departing from the spirit and scope of the invention.

1. A method for relating test recipe, product, and test equipment, comprising:
a. including said test recipe and a test material model within a manufacturing execution system infrastructure;
b. setting said test recipe according to a product class, a sort stage and a test data within said manufacturing execution system;
c. providing the capability to set said test equipment's configuration;
d. providing the capability to request required said test equipment's configuration for each of said product within said manufacturing execution system, and
e. providing for said test equipment's capability status.

2. The method of claim 1, wherein said relating is based on actual behavior of product.

3. The method of claim 1, wherein a test program, product file, and probe card are modeled into said manufacturing execution system infrastructure.

4. The method of claim 1, wherein said test equipment's capability status is built into said test equipment's properties.

5. The method of claim 4, wherein the required said test equipment's configuration is built into said product class.

6. The method of claim 5, wherein real-time lot to equipment dispatch mechanism is applied according to the required configuration.

7. The method of claim 1, wherein a chip probing program provides the infrastructure through a Specification Manager capability.

8. The method of claim 7, wherein product ID, main process, module process, process, and logic recipe architectural classes of said chip probing program are used to model a user's product and sort entity.

9. The method of claim 7, wherein said chip probing program equipment recipe architectural class is used to model user's test program.

10. The method of claim 7, wherein said logic recipe class of said chip probing program contains recipe parameters with upper and lower limits to define request capability.

11. The method of claim 8, wherein said test equipment's capability status is kept in a new status table.

12. The method of claim 1, wherein a simplified model supported by the current systems I-EDA and PCMS can be used until conversion is complete.

13. The method of claim 12, wherein the probe card or probe card group are not modeled into said chip probing program, but comes from said PCMS information.

14. The method of claim 13, wherein said I-EDA language provides Bin Definition ID and TSPEC instead of it being defined in said chip probing program Specification Manager.

15. A system for test recipe, product, and test equipment, comprising:
a. a means to include said test recipe and a test material model within a manufacturing execution system infrastructure;
b. a means to set said test recipe according to a product class, a sort stage and a test data within said manufacturing execution system;
c. a means to provide the capability to set said test equipment's configuration;
d. a means to provide the capability to request required said test equipment's configuration for each of said product within said manufacturing execution system, and
e. a means to provide for said test equipment's capability status.

16. The system of claim 16, wherein said relating is based on actual behavior.

17. The system of claim 16, wherein a test program, product file, and probe card are modeled into said manufacturing execution system infrastructure.

18. The system of claim 16, wherein said test equipment's capability status is built into said test equipment's properties.

19. The system of claim 19, wherein the required said test equipment's configuration is built into said product class.

20. The system of claim 20, wherein real-time lot to equipment dispatch mechanism is applied according to the required configuration.

21. The system of claim 16, wherein a chip probing program provides the infrastructure through its Specification Manager capability.

22. The system of claim 22, wherein product ID, main process, module process, process, and logic recipe architectural classes of said chip probing program are used to model a user's product and sort entity.

23. The system of claim 23, wherein said chip probing program equipment recipe architectural class is used to model user's test program.

24. The system of claim 23, wherein said logic recipe class of said chip probing program contains recipe parameters with upper and lower limits to define request capability.

25. The system of claim 24, wherein said test equipment's capability status is kept in a new status table.

26. The system of claim 15, wherein a simplified model supported by the current systems I-EDA and PCMS can be used until conversion is complete.

27. The system of claim 26, wherein the probe card or probe card group are not modeled into said chip probing program, but comes from said PCMS information.

28. The system of claim 27, wherein said said I-EDA language provides Bin Definition ID and TSPEC instead of it being defined in said chip probing program Specification Manager.
